(19) United States
(12) Patent Application Publication
(10) Pub. No.: US 2025/0068839 A1
(43) Pub. Date: Feb. 27, 2025

(54) Evaluate Natural Language Parser Using Frequent Pattern Mining

(71) Applicant: International Business Machines Corporation, Armonk, NY (US)

(72) Inventors: Yohei Ikawa, Yokohama-shi (JP); Issei Yoshida, Tokyo (JP)

(21) Appl. No.: 18/236,355

(22) Filed: Aug. 21, 2023

(51) Int. Cl. G06F 40/205

(52) U.S. Cl. CPC G06F 40/205

(57) ABSTRACT

Techniques for evaluating a natural language parser are provided. In one aspect, a natural language parser evaluation system includes: a natural language parser; and an evaluator configured to receive outputs of the natural language parser and gold data for a same set of texts, find patterns in the outputs of the natural language parser and in the gold data independently, determine error rates for each of the patterns, calculate a score for a change in the error rates between each of the patterns and sub-patterns of the patterns, rank the patterns by the error rates, and remove one or more of the patterns based on a minimum of the score to provide a ranked and filtered list of the patterns for error analysis of the natural language parser. A method for evaluating a natural language parser using the present system is also provided.

### FIELD OF THE INVENTION

The present invention relates to natural language processing, and more particularly, to techniques for evaluating a natural language parser using frequent pattern mining.

### BACKGROUND OF THE INVENTION

Natural language processing enables computers to understand human language as it is spoken and written. Parsing plays a key role in natural language processing by breaking a sentence down into smaller components based on grammatical structure in order to analyze the syntax and underlying structure of the sentence and extract meaning from it. Some exemplary natural language parsers include a part-of-speech (POS) tagging parser and a dependency parser.

An important metric in assessing natural language processing performance is to be able to effectively evaluate the output of the natural language parser. The cause of errors needs to be identified and analyzed in order to make improvements to the parser. To do so, parser output can be compared with ground truth data to find differences between them. The results can then be used to generate a quantitative score that rates the overall performance of the parser. However, this approach does not explain what causes actual errors since all it provides are numerical scores, like 90%.

Therefore, a more comprehensive approach to natural language parser performance evaluation would be desirable.

### SUMMARY OF THE INVENTION

The present invention provides techniques for evaluating a natural language parser using frequent pattern mining. In one aspect of the invention, a natural language parser evaluation system is provided. The natural language parser evaluation system includes: a natural language parser; and an evaluator configured to receive outputs of the natural language parser and gold data for a same set of texts, find patterns in the outputs of the natural language parser, determine error rates for each of the patterns found, calculate a score DiffCause for a change in the error rates between each of the patterns and sub-patterns of the patterns, rank the patterns in descending order by the error rates to provide a ranked list, and remove one or more of the patterns from the ranked list based on MinDiffCause which is a minimum of the score for the one or more patterns being below a threshold θ to provide a ranked and filtered list of the patterns for error analysis of the natural language parser.

In another aspect of the invention, a method for evaluating a natural language parser is provided. The method includes: receiving outputs of the natural language parser and gold data for a same set of texts; finding patterns in the outputs of the natural language parser and in the gold data independently; determining error rates for each of the patterns found; calculating a score DiffCause for a change in the error rates between each of the patterns and sub-patterns of the patterns; ranking the patterns in descending order by the error rates to provide a ranked list; and removing one or more of the patterns from the ranked list based MinDiffCause which is a minimum of the score for the one or more patterns being below a threshold θ to provide a ranked and filtered list of the patterns for error analysis of the natural language parser.

In yet another aspect of the invention, another method for evaluating a natural language parser is provided. The method includes: receiving outputs of the natural language parser and gold data for a same set of texts; finding frequent patterns in the outputs of the natural language parser and in the gold data independently, wherein the frequent patterns comprise itemsets that occur at least a predetermined number of times independently in either the outputs of the natural language parser or in the gold data; determining error rates for each of the patterns found based on a degree of overlap between a first text set derived from the outputs of the natural language parser and a second text set derived from the gold data for a given one of the patterns based on an overlap of the texts that includes the given pattern in both the first text set and the second text set; calculating a score DiffCause for a change in the error rates between each of the patterns and sub-patterns of the patterns; ranking the patterns in descending order by the error rates to provide a ranked list; and removing one or more of the patterns from the ranked list based on MinDiffCause which is a minimum of the score for the one or more patterns being below a threshold θ to provide a ranked and filtered list of the patterns for error analysis of the natural language parser.

A more complete understanding of the present invention, as well as further features and advantages of the present invention, will be obtained by reference to the following detailed description and drawings.

### BRIEF DESCRIPTION OF THE DRAWINGS

FIG. 1 is a diagram illustrating an exemplary computing environment according to an embodiment of the present invention;

FIG. 2 is a diagram illustrating an exemplary natural language parser evaluator system according to an embodiment of the present invention;

FIG. 3 is a diagram providing an exemplary text Tₖ, and corresponding natural language parser output Nₖ and gold data Gₖ according to an embodiment of the present invention;

FIG. 4 is a diagram illustrating exemplary text sets Tₙₗₚ(P) and T_{gold}(P) derived by the evaluator from outputs of the natural language parser and gold data, respectively, for a pattern P according to an embodiment of the present invention;

FIG. 5 is a diagram illustrating an exemplary methodology for evaluating a natural language parser according to an embodiment of the present invention;

FIG. 6 is a diagram illustrating use of the present DiffCause scoring for a change in the error rate between a pattern P and its respective sub-patterns P′ according to an embodiment of the present invention;

FIG. 7 is a diagram illustrating an example where the present natural language parser evaluator system is used to compare different candidate models according to an embodiment of the present invention;

FIG. 8 is a table displaying an exemplary ranking of patterns by F1 value according to an embodiment of the present invention;

FIG. 9 is a table displaying an exemplary filtering of the patterns by MinDiffCause score according to an embodiment of the present invention;

FIG. 10 is a diagram illustrating a transition of text sets Td(P) and T_{gold} (P) with pattern growth for reduced pattern item E′={INTJ, SYM, VERB} according to an embodiment of the present invention;

FIG. 11 is a table displaying all of the patterns for the reduced items E′ as well as the results of ranking and score calculation according to an embodiment of the present invention; and

FIG. 12 is a table displaying a ranked and filtered list of patterns according to an embodiment of the present invention.

### DETAILED DESCRIPTION OF PREFERRED EMBODIMENTS

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

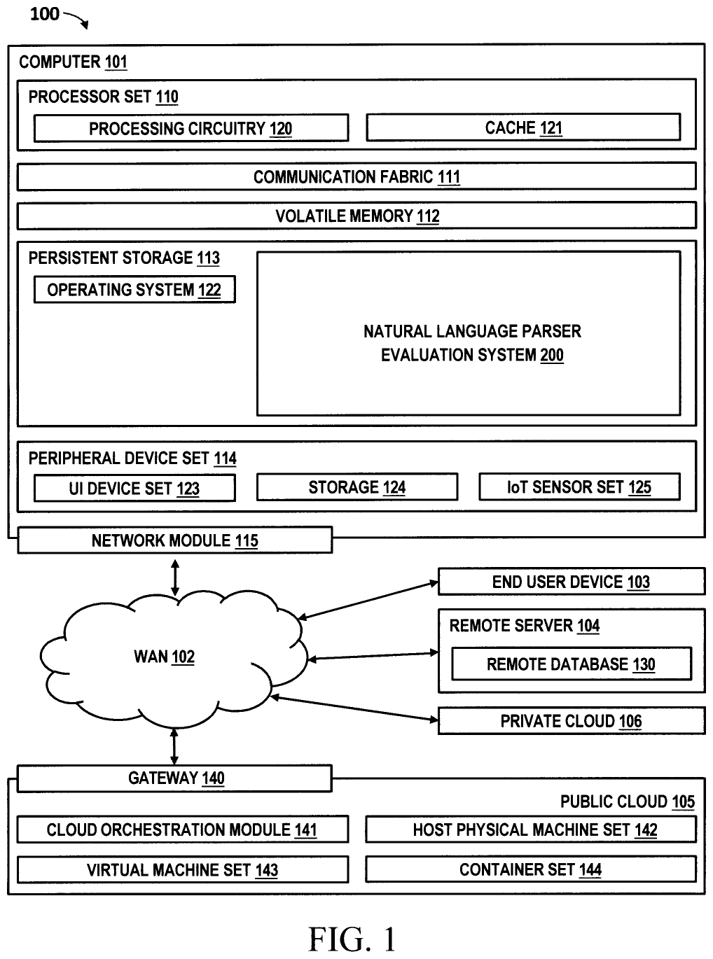

Referring to FIG. 1, computing environment 100 contains an example of an environment for the execution of at least some of the computer code involved in performing the inventive methods, such as natural language parser evaluation system 200. In addition to system 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and system 200, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in system 200 in persistent storage 113.

COMMUNICATION FABRIC 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in system 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

As highlighted above, while simply comparing the output of a natural language parser (or simply ‘parser’) to ground truth data can highlight the overall performance of the parser, doing so has limited utility in explaining the actual cause of errors. Thus, a more meaningful metric is needed to evaluate parser performance and illuminate errors in order to determine where improvements can be made.

Advantageously, provided herein are techniques for uncovering significant error patterns in the parser output. In that regard, it may seem natural to simply apply standard data mining approaches to the parser output to enumerate typical, frequent error patterns. However, simply taking differences in these error patterns between the parser output and ground truth data inevitably yields too many patterns, which makes it virtually impossible to identify which of the patterns are the most relevant to the occurrence of significant errors. The term ‘ground truth data’ (also used interchangeably herein with the term ‘gold data’) refers to the ideal expected output from, in this case, the parser. It is considered to be the proper objective data for judging performance of the parser. For instance, if the parser labels a word in a text as NOUN whereas it is labeled VERB in the ground truth data, then it may be assumed that the parser has made an error.

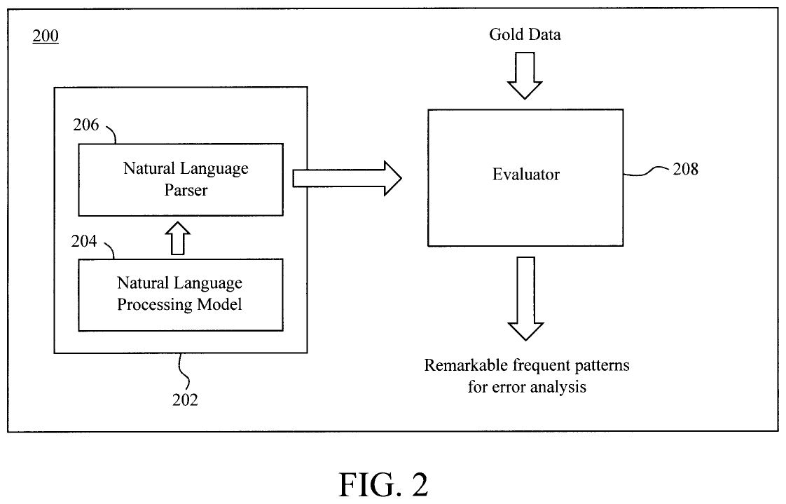

Notably, the present approach is directed to extracting only those remarkable patterns from all of the mined frequent patterns that are useful for error analysis. As its name implies, a frequent pattern is a pattern that appears frequently within a dataset. By way of example only, FIG. 2 is a diagram illustrating an exemplary configuration of system 200. As shown in FIG. 2, system 200 includes a natural language processor 202 having a natural language model 204 and a natural language parser 206, and an evaluator 208. As highlighted above, natural language processor 202 is a computer-based tool for understanding human language as it is spoken and written. The natural language model 204 component of natural language processor 202 is a statistical model that provides information to the parsing algorithm in the natural language processor 202. The model may be implemented as a probabilistic model with respect to the probability of a sequence of words. For a given implementation of the natural language processor 202, different models may give a different behavior of the processor. The natural language parser 206 component of natural language processor 202 takes text generated by the natural language model 204 and analyzes syntactical relationships between words and phrases therein.

In general, natural language parser 206 can be any parsing tool suitable for syntax analysis during natural language processing such as, but not limited to, a part-of-speech (POS) tagging parser, or a dependency parser. A POS tagging parser categorizes words in a text with respect to a particular part of speech based on the definition of a word and its context. A dependency parser looks at the dependencies between phrases in a sentence in order to determine grammatical structures, and divides the sentence into smaller components based on these grammatical structures.

As will be described in detail below, the evaluator 208 is configured to take output N from the natural language parser 206 given an input set of texts T. Evaluator 208 finds frequent patterns in N. Evaluator 208 then identifies a subset of remarkable patterns for error analysis by sorting, scoring, and filtering the frequent patterns, by using the information of N and the ground truth or gold data for T.

For clarity, a description of the relevant terminology is now provided. As highlighted above, the present techniques leverage both output from the natural language parser 206 and ground truth or gold data. For illustrative purposes only, POS tagging will be used as the output in the examples given herein. However, as highlighted above, it is to be understood that the present techniques are more generally applicable to the evaluation of any type of parsing tool used for syntax analysis during natural language processing, e.g., a POS tagging parser, a dependency parser, etc. Thus, in this scenario it is assumed that the output of the natural language parser 206 is a list of tags, where each of the tags is associated with a word in a text. For example, when an input text to the natural language parser 206 is “The birds fly,” then the output of POS tagging from natural language parser 206 might be,
Text (which is also provided by natural language parser 206): “The birds fly”
POS tag list: ‘NOUN, NOUN, VERB.’However, if the POS tag list in the gold data for this same input text is ‘DET, NOUN, VERB,’ then the output from the natural language parser 206 in this case is wrong, namely the POS tag for the first word is different, i.e., ‘DET’ in the gold data while ‘NOUN’ in the output from the natural language parser 206. As is known to those in the art, tags such as DET, NOUN, VERB, etc. are used by natural language parsers to label parts of speech such as determiner/article, noun, verb, etc. According to an exemplary embodiment, the gold data is manually annotated and verified. Large repositories of annotated and verified gold data for natural language parsers are publicly available.

As also highlighted above, the evaluator 208 leverages frequent pattern mining techniques. For instance, for a single set of texts (i.e., corpus), it is assumed that the evaluator 208 receives (independently from the natural language parser 206 and gold data) a set of tag lists L={L₁, . . . , Lₙ} where Lᵢ is a list of tags for Tᵢ, the i-th input text in T. For example, Lₖ=(DET,NOUN,VERB) for Tₖ=“The birds fly”. Frequent pattern mining techniques, such as frequent itemset mining or frequent sequence mining, enumerate frequent (sub-)patterns from L. Specifically, frequent itemset mining enumerates patterns as unordered tag sets (itemsets) such as {DET,NOUN}. In the present example, Lₖ contains {DET,NOUN} and {VERB, NOUN}.

On the other hand, frequent sequence mining enumerates patterns as ordered tag sets such as [DET, NOUN]. For instance, in the present example, Lₖ contains [DET, NOUN] but does not contain [VERB, NOUN] (since the order is reversed). In general, the term ‘pattern’ as used herein refers to any repeated occurrence of items, such as tag sets (itemsets) or tag sequences in this example. Thus, for instance, if the tag set {DET,NOUN} appears multiple times in either the output from the natural language parser 206 or the gold data, then {DET,NOUN} is considered to be a particular pattern P. However, according to an exemplary embodiment, a threshold value is used during the pattern mining to define when a discovered pattern P is frequent. For instance, in one exemplary embodiment, the threshold value for the frequency of an itemset such as {DET,NOUN} is greater than or equal to (≥) 10. In that case, {DET, NOUN} is a frequent pattern in the output from the natural language parser 206 or the gold data if it appears at least 10 times in the output from the natural language parser 206 or the gold data, respectively.

However, simply applying frequent pattern mining to the output from the natural language parser 206 and the gold data inevitably results in too many frequent patterns being found which, as highlighted above, makes it virtually impossible to identify the most relevant patterns. For instance, in an experiment applying the present techniques (described in detail below), 7,231 frequent itemsets were found in the POS tagging results from 13,158 texts.

Advantageously, the evaluator 208 then further processes the frequent patterns to uniquely identify which of those patterns are the most relevant to use for error analysis of the natural language parser 206. Namely, using the single set (i.e., corpus) of texts (see above), i.e., T={T₁, . . . , Tₙ}, evaluator 208 derives two text sets for each given pattern P. One text set is derived from the natural language parser 206 outputs N={N₁, . . . , Nₙ} and the other text set derived from the gold data G={G₁, . . . , Gₙ}. According to an exemplary embodiment, T={T₁, . . . , Tₙ} is generated by the natural language model 204. The term ‘text’ as used herein generally refers to any words that are written, typed, printed, etc., and the texts in the instant corpus can each include a single word or multiple words including those arranged into sentences, phrases, etc. As highlighted above, the instant scenario uses POS tagging as an example. In that case, both the natural language parser 206 outputs and the gold data include lists of part-of-speech tags, such as (NOUN,NOUN,VERB), (DET,NOUN,VERB), etc.

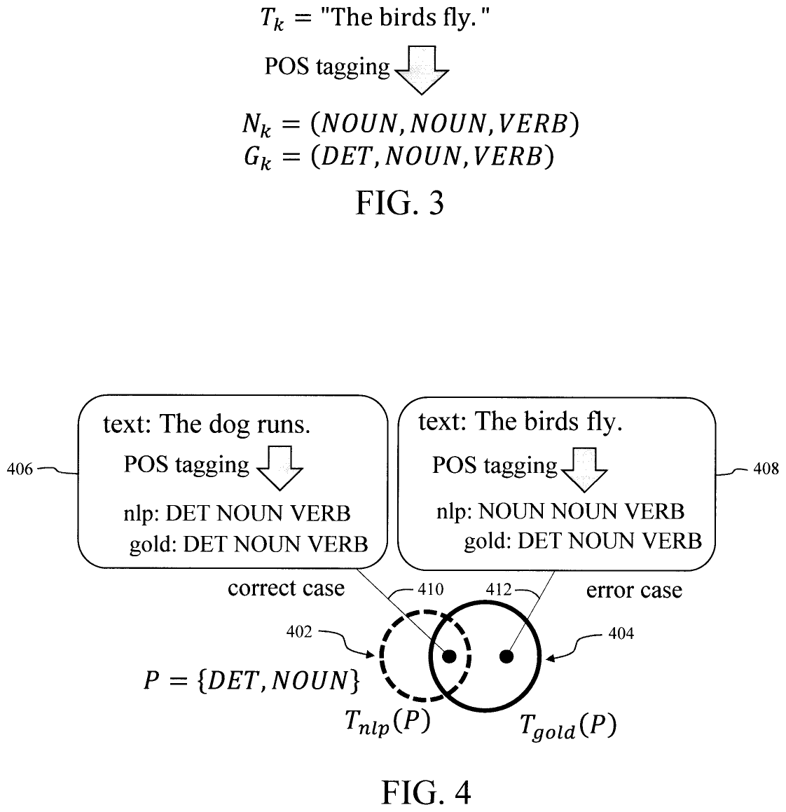

For instance, using “The birds fly” as the underlying text Tₖ, FIG. 3 shows examples of an Nₖ and Gₖ which may be independently obtained for Tₖ from the natural language parser 206 output and the gold data, respectively. In this particular example, the corresponding natural language parser 206 output Nₖ with POS tagging is:

Nₖ=(NOUN,NOUN,VERB),

while the corresponding POS tagging from the gold data Gₖ is:

Gₖ=(DET,NOUN,VERB).

As noted above, POS tagging is being used merely as a non-limiting, illustrative example, and other parsing tools such as a dependency parser may be used in accordance with the present techniques. As would be apparent to those skilled in the art, by comparison with the POS tagging used in the instant example, dependency parser labeling forms a tree structure where, for the same underlying text Tₖ=“The birds fly”, the dependency labeling would instead be (fly[VERB](birds[NOUN](the[DET])) to which the present techniques could be applied in the same manner described.

As highlighted above, evaluator 208 finds patterns in N={N₁, . . . , Nₙ} and G={G₁, . . . , Gₙ} using frequent pattern mining, and then derives two text sets for each pattern P found. An example of these two text sets is shown illustrated in FIG. 4. Referring to FIG. 4, one of the text sets Tₙₗₚ(P) is derived from the natural language parser 206 (nlp) outputs N={N₁, . . . , Nₙ} and the other text set T_{gold}(P) is derived from the gold data (gold) G={G₁, . . . , Gₙ}. Specifically, in this example, circle 402 (with a dashed outline) depicts the text set Tₙₗₚ(P) where the natural language parser 206 outputs N={N₁, . . . , Nₙ} match the pattern P. Circle 404 (with a solid outline) depicts the text set T_{gold}(P) where the gold data G={G₁, . . . , Gₙ} match the pattern P. For illustrative purposes only, in this example P={DET,NOUN}.

Insets 406 and 408 further illustrate examples of a correct case (where the natural language parser 206 output matches the gold data) and an error case (where the natural language parser 206 output does not match the gold data), respectively, for the same underlying texts. For instance, inset 406 depicts a correct case scenario where, for the same underlying text Tₖ “The dog runs,” the POS tagging in the gold data (Gₖ=(NOUN,NOUN,VERB)) matches that from the natural language parser 206 output (Nₖ=(NOUN,NOUN,VERB)). Thus, as indicated by line 410, this instance falls within both (i.e., within the overlap of) the text set Tₙₗₚ(P) (circle 402) and text set T_{gold}(P) (circle 404), meaning that the natural language parser 206 output and the gold data both match the pattern P={DET,NOUN} for the same underlying text Tₖ “The dog runs.”

By contrast, inset 408 depicts an error case scenario where, for another underlying text Tₖ“The birds fly,” the POS tagging in the gold data (Gₖ=(DET,NOUN,VERB)) does not match that from the natural language parser 206 output (Nₖ=(NOUN,NOUN,VERB)). Thus, as indicated by line 412, this instance falls within the text set T_{gold}(P) (circle 404) but outside of the text set Tₙₗₚ(P) (circle 402), meaning that the gold data matches the pattern P={DET,NOUN} but the natural language parser 206 output does not match the pattern P={DET,NOUN} for the same underlying text Tₖ “The birds fly.”

Advantageously, this approach enables the evaluator 208 to evaluate each pattern P by the rate of deviation of that pattern P between the gold data and the natural language parser 206 output, by using the overlap of the underlying texts that include the pattern P in both the gold data and the natural language parser 206 output. An exemplary embodiment where the rate of deviation of a pattern P between the gold data and the natural language parser 206 output is determined using an F1 value, i.e., F1(P), is provided below whereby a lower F1(P) value means a higher deviation between the gold data and the natural language parser 206 output, and vice versa.

As exemplified above, each pattern P is a tag set (also referred to herein as an ‘itemset’) containing tags (or items). Thus, the terms ‘tag’ and ‘item’ may be used interchangeably herein. For instance, the exemplary pattern P={DET,NOUN} contains the label (item) DET and the label (item) NOUN. As will be described in detail below, if any single pattern P has a label (item) e such that a minimum change in the error rates between P and P−{e} (i.e., a sub-pattern of P obtained by reducing one item e in P)—MinDiffCause—is below a threshold θ, then the evaluator 208 can remove pattern P to suppress redundant patterns. Doing so reduces the number of output patterns without sacrificing the quality of the output patterns.

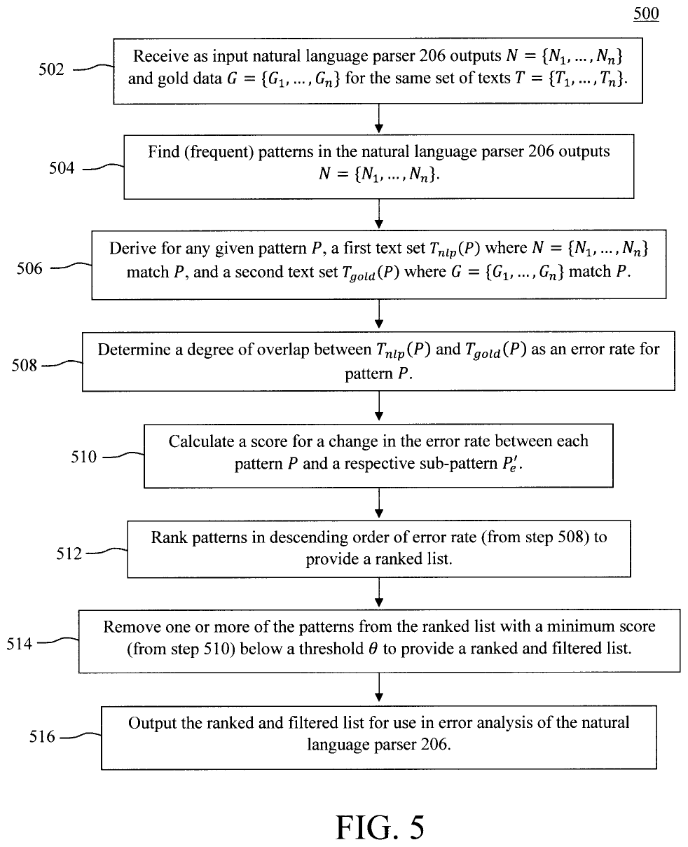

Given the above overview, an exemplary methodology 500 for evaluating a natural language parser such as natural language parser 206 of system 200 is now described by way of reference to FIG. 5. According to an exemplary embodiment, one or more of the steps of methodology 500 are performed by the evaluator 208 of system 200. In step 502, the evaluator 208 receives as input the natural language parser 206 outputs N={N₁, . . . , Nₙ} and the gold data G={G₁, . . . , Gₙ} for the same, single set (i.e., corpus) of texts T={T₁, . . . , Tₙ}. An exemplary text Tₖ, and corresponding natural language parser 206 output Nₖ and gold data Gₖ were provided in FIG. 3, and described above.

In step 504, the evaluator 208 finds patterns in the natural language parser 206 outputs N={N₁, . . . , Nₙ}. According to an exemplary embodiment, evaluator 208 uses frequent pattern mining in step 504 such that the patterns found in the natural language parser 206 outputs N={N₁, . . . , Nₙ} are frequent patterns. By ‘frequent pattern’ it is meant that a tag set (itemset) occur at least a predetermined number of times independently in the natural language parser 206 outputs N={N₁, . . . , Nₙ}. In one embodiment, the threshold value for the frequency (also referred to herein as a ‘frequency threshold’) of an itemset such as {DET,NOUN} is ≥10. In that case, {DET,NOUN} is a frequent pattern in the output from the natural language parser 206 if it occurs at least 10 times in the output from the natural language parser 206.

Embodiments are contemplated herein where evaluator 208 uses an available frequent pattern mining algorithm to find the frequent patterns in the natural language parser 206 outputs N={N₁, . . . , Nₙ}. Suitable frequent pattern mining algorithms that may be used in accordance with the present techniques include, but are not limited to, the apriori algorithm and/or the equivalence class clustering and bottom-up lattice traversal (ECLAT) algorithm. For instance, the apriori algorithm uses a bottom-up approach to identify frequent itemsets from a text corpus and then generates association rules from those itemsets, whereas the ECLAT algorithm uses a depth-first search approach to find frequent itemsets. However, as highlighted above, this frequent pattern search is still expected to yield too many patterns to be able to identify which are the most relevant to the occurrence of significant errors.

Thus, the patterns found in step 504 are next ranked (based on their error rate) and scored to enable the filtering out (i.e., removal) of low scoring patterns in order to give a more meaningful result for error analysis. According to an exemplary embodiment, the error rate is determined as a degree of overlap between the outputs of the natural language parser 206 and the gold data for each of the patterns. To do so, in step 506 two text sets are derived for each pattern P found in step 504, one where the natural language parser 206 outputs N={N₁, . . . , Nₙ} match a given one of the patterns P(Tₙₗₚ(P)), and another where the gold data G={G₁, . . . , Gₙ} match that same given pattern P(T_{gold} (P)) and, in step 508, a degree of overlap between those text sets Tₙₗₚ(P) and T_{gold}(P) is determined as the error rate for each respective pattern P. Referring briefly back to FIG. 4, this degree of overlap determination is based on the overlap of the underlying texts T={T₁, . . . , Tₙ} that includes a given pattern P in both text sets Tₙₗₚ(P) and T_{gold}(P). For instance, using the scenario depicted in FIG. 4 for a given pattern P, the overlap of the underlying text “The dog runs” includes the pattern P={DET,NOUN} in both the text set Tₙₗₚ(P) and the text set T_{gold}(P). See line 410 in FIG. 4 which points to the overlap between these two text sets, i.e., a correct case. Thus, the ‘text’ in the text sets refers to the underlying text (e.g., “The dog runs”). For example, Tᵢ=“The dog runs,” Gᵢ=(DET,NOUN,VERB). Then, T_{gold}(P)={Tᵢ|Gᵢ matches pattern P}. For ease and clarity of description, the terms ‘first’ and ‘second’ may also be used herein when referring to the text sets Tₙₗₚ(P) and the T_{gold}(P), respectively. It is notable that the degree of overlap between the text set Tₙₗₚ(P) and the text set T_{gold}(P) is also indicative of a degree of difference between those same text sets. In other words, outside of where the text sets Tₙₗₚ(P) and T_{gold}(P) overlap, they are different from one another. See line 412 in FIG. 4 which points to the error case of an underlying text “The birds fly” where T_{gold}(P) includes the pattern P={DET,NOUN}, but Tₙₗₚ(P) does not. The degree of this difference between the text set Tₙₗₚ(P) and the text set T_{gold}(P) depends on the degree they overlap, and vice versa. Thus, the term ‘error rate’ as used herein generally refers to a ratio of the number of error cases to the total number of cases (error+correct) in the data. Naturally, the greater the degree of overlap (and thus the greater the F1 or Jaccard coefficient value) the lower the error rate, and vice versa.

The degree of overlap between the text sets Tₙₗₚ(P) and T_{gold}(P) determined in step 508 indicates an error rate for each pattern P found in step 504. This ‘error rate’ signifies a number of errors for a given pattern P (based on the underlying texts) as compared to all of the other patterns discovered which, as described in detail below, will be used to rank the patterns. According to an exemplary embodiment, F1 scoring is used to determine the degree of overlap for each pattern P. Hereinafter, the designation F1(P) represents the F1 score for a given pattern P.

In the context of machine learning, an F1 score is generally used as an evaluation metric for machine learning models based on precision and recall. Here specifically, precision can be calculated as:

$$precision = \frac{\vert {T}_{nlp} ( P ) ⋂ {T}_{gold} ( P ) \vert}{\vert {T}_{nlp} ( P ) \vert} ,$$

and recall can be calculated as:

$$recall = \frac{\vert {T}_{nlp} ( P ) ⋂ {T}_{gold} ( P ) \vert}{\vert {T}_{gold} ( P ) \vert} .$$

Accordingly, the F1 score for degree of overlap is:

$$F 1 = \frac{2 \times precision \times recall}{precision + recall} .$$

It is notable, however, that any suitable metric for determining the degree of overlap between the two text sets Tₙₗₚ(P) and T_{gold}(P) may be used in accordance with the present techniques, and the use of an F1 score is merely one exemplary embodiment. For instance, by way of example only, embodiments are also contemplated herein where the degree of overlap between the two text sets Tₙₗₚ(P) and T_{gold}(P) is calculated based on Jaccard coefficient values. As is known to those of skill in the art, the Jaccard coefficient is a value between 0 and 1, where a value of 0 indicates no overlap between the two text sets Tₙₗₚ(P) and the T_{gold}(P), and a value of 1 indicates complete overlap of the two text sets Tₙₗₚ(P) and the T_{gold}(P). The Jaccard coefficient can be calculated simply by counting the total number of shared items (i.e., underlying texts) in both text sets Tₙₗₚ(P) and T_{gold}(P), and then dividing this number by the distinct items in both Tₙₗₚ(P) and T_{gold}(P) combined.

Notably, the patterns with a low degree of overlap between Tₙₗₚ(P) and T_{gold}(P) (as signified by a low F1 score or low Jaccard coefficient value) and thus a higher error rate are considered herein to be remarkable as error patterns. As such, the patterns will later be ranked in descending order of their error rates (with the patterns having the highest error rates at the top of the list, and the patterns having the lowest error rates at the bottom of the list). However, this ranked list of the patterns will still contain many redundant patterns. As will be described in detail below, a redundant pattern is a pattern that can be represented by a simpler sub-pattern.

Advantageously, provided herein is a metric that is then applied to filter the ranked list of patterns in order to suppress redundant patterns by removing them from the list. In step 510, this metric (DiffCause) calculates a score relating to how each pattern P found can be broken down into a smaller, simpler sub-pattern P′. DiffCause(P,e) scores the degree by which item e causes a difference in the error rate between a pattern P and sub-pattern P−{e}. Depending on the score, the respective sub-pattern P′ may instead be used, thereby filtering out/removing pattern P (which is redundant) from the ranked list. Generally, DiffCause(P) scores a change in the error rate between a given pattern P and its respective sub-pattern P′ and, if that change is less than a threshold value, then pattern P can be removed in favor of sub-pattern P′ which exists as a simpler pattern to explain the error.

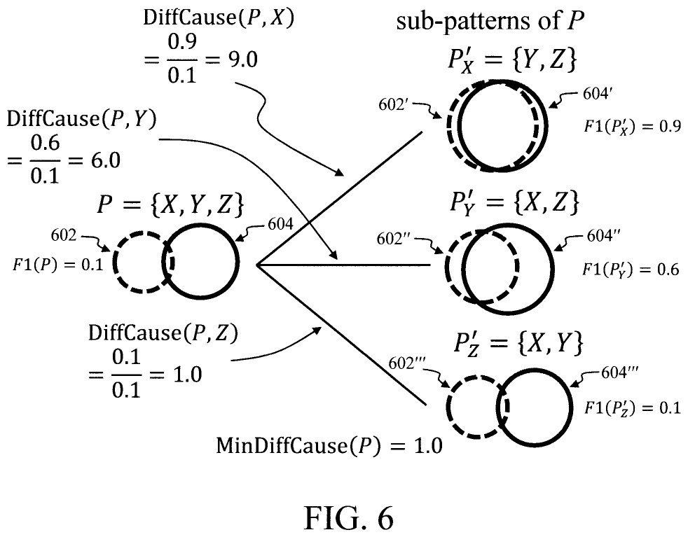

An exemplary embodiment implementing the present DiffCause scoring is now described by way of reference to FIG. 6. For illustrative purposes only, F1 is used as the metric for the degree of overlap between Tₙₗₚ(P) and T_{gold}(P) in order to determine the error rate for each pattern P. However, as provided above, other approaches for determining the degree of overlap between Tₙₗₚ(P) and T_{gold}(P) are also contemplated herein such as, but not limited to, the Jaccard coefficient. In that case, one skilled in the art would be able to easily substitute the Jaccard coefficient value for F1(P) in the calculations below in order to implement this other metric.

Referring to FIG. 6, for a pattern P which contains an itemset such as {DET,NOUN}, let sub-pattern P′ₑ be P−{e} (reduce one item e in P). In other words, sub-pattern P′ₑ is created by removing one item e from the itemset of pattern P. Thus, to use an illustrative example, if P={DET,NOUN}, and e=NOUN, then P′ₑ={DET}. In FIG. 6, the itemsets of pattern P are represented generically using X, Y and Z, i.e., P={X,Y,Z}. Thus, a sub-pattern P′ₑ where e=X is Pk={Y,Z} meaning that X is the item e removed from P={X,Y,Z}. In the same manner, a sub-pattern P′ₑ where e=Y is P′Y={X,Z}, and a sub-pattern P′ₑ where e=Z is P′Z={X,Y}. As such, by this process, a pattern P={X,Y,Z} can be broken down into multiple sub-patterns P′ₑ, i.e., in this example sub-patterns P′_{X}={Y,Z}, P′_{Y}={X,Z} and P′_{Z}={X,Y}.

Using F1 as the error rate metric in this example, the ratio of F1(P′ₑ) to F1(P) scores the change in error rate between the pattern P and a sub-pattern P′ₑ as:

$$DiffCause ( P , e ) = \frac{F 1 ( P {′}_{e} )}{F 1 ( P )} = \frac{F 1 ( P - \{ e \} )}{F 1 ( P )} ,$$

where the computed DiffCause(P,e) is the score that will be used to filter-out redundant patterns from the ranked list. Referring to the example in FIG. 6, the F1(P) of pattern P={X,Y,Z} is 0.1, and the F1(P′_{X}) of sub-pattern P′X={Y,Z} is 0.9. Thus, the

$$DiffCause ( P , X ) = \frac{0.9}{0.1} = 9. .$$

Likewise, the F1 P′_{Y}) of sub-pattern P′_{Y}={X,Z} is 0.6. Thus, the

$$DiffCause ( P , Y ) = \frac{0.6}{0.1} = 6. .$$

The F1(P′_{Z}) of sub-pattern P′_{Z}={X,Y} is 0.1. Thus, the

$$DiffCause ( P , Z ) = \frac{0.1}{0.1} = 1. .$$

The text sets Tₙₗₚ(P) and T_{gold}(P) for pattern P={X,Y,Z}, and sub-pattern P′_{X}={Y,Z}, P′_{Y}={X,Z}, and P′_{Z}={X,Y} are depicted using circles 602, 602′, 602″, 602″′ (with a dashed outline) and circles 604, 604′, 604″, 604″′ (with a solid outline), respectively. As above, this graphic helps illustrate the degree of overlap between the two text sets in each instance.

By this process, a score DiffCause is calculated for each possible (in this case multiple) sub-pattern P′ₑ derived by eliminating a single item e from the item list P={X,Y,Z}, one at a time. In other words, as shown in FIG. 6, eliminating item X from P={X,Y,Z} results in a score DiffCause(P,X)=9.0, eliminating item Y from P={X,Y,Z} results in a score DiffCause(P,Y)=6.0, and eliminating item Z from P={X,Y,Z} results in a score DiffCause(P,Z)=1.0. From those results, the sub-pattern P′ₑ score having the lowest value (among the multiple sub-patterns) is selected to represent the MinDiffCause for pattern P. For instance, the MinDiffCause for a pattern P is defined as:

$$Min DiffCause ( P ) = min \{ DiffCause ( P , e ) \vert e ∈ P \} .$$

In the example depicted in FIG. 6, DiffCause(P,X)=9.0, DiffCause(P,Y)=6.0, and DiffCause(P,Z)=1.0. As such, the minimum DiffCause score, that of sub-pattern P′_{Z}={X,Y}, is the MinDiffCause for pattern P, i.e., MinDiffCause(P)=1.0. A tunable threshold θ is set whereby any pattern P having a MinDiffCause(P) below the threshold θ is filtered out (i.e., removed from the ranked list—see below) as there is a simpler, sub-pattern to explain the error. According to an exemplary embodiment, threshold θ is greater than (>) 1.0. Thus, all patterns with MinDiffCause(P)≤1.0 will be filtered out. To again use the example depicted in FIG. 6 as an illustration, in that case the MinDiffCause for pattern P is 1.0. With θ>1.0, pattern P is thus removed from the ranked list based on the notion that there exists a simpler sub-pattern P′ₑ (in this example sub-pattern P′_{Z}={X,Y}) to explain the error. In one embodiment, threshold θ is a user-tunable parameter which can be lowered or raised to respectively decrease or increase the number of patterns output.

In step 512, the error rate (determined, for example, as the degree of overlap between the text sets Tₙₗₚ(P) and T_{gold}(P) in step 508) is then used to rank the (frequent) patterns. According to an exemplary embodiment, the (frequent) patterns are ranked in descending order of error rate. Doing so produces a ranked list where the higher the error rate, the higher a given (frequent) pattern P is on the list, and vice versa. Further, as highlighted above, the greater the degree of overlap (and thus the greater the F1 or Jaccard coefficient value) the lower the error rate, and vice versa. Thus, this same ranking may also be achieved using the degree of overlap where, for example, the (frequent) patterns are ranked in ascending order of F1 or Jaccard coefficient value. In either case (i.e., descending order of error rate or ascending order of F1/Jaccard coefficient value), the resulting ranked list should be the same.

As described in detail above, the ranked list is expected to contain redundant patterns. For instance, the ranked list can include a given pattern P and a simpler sub-pattern P′ₑ which can also explain the error (i.e., can produce almost the same error). In that case, the given pattern P is considered redundant, and is removed from the ranked list in favor of the simpler sub-pattern P′ₑ in order to reduce the overall number of patterns reported. This pruning is done based on the above-described DiffCause score. Namely, in step 514, one or more of the patterns having a minimum DiffCause score (from step 510), referred to herein as MinDiffCause, below a threshold θ is removed from the ranked list. According to an exemplary embodiment, threshold θ>1.0.

Thus, to again use the example from FIG. 6 as an illustration, for pattern P={X,Y,Z}, the DiffCause(P,X)=9.0, DiffCause(P,Y)=6.0, and DiffCause(P,Z)=1.0 for sub-patterns P′_{X}={Y,Z}, P′_{Y}={X,Z} and P′_{Z}={X,Y}, respectively. It is assumed that the pattern P={X,Y,Z} as well as the sub-patterns P′_{X}={Y,Z}, P′_{Y}={X,Z} and P_{Z}={X,Y} are present in the ranked list, and the question is whether the pattern P={X,Y,Z} can be removed from the list in favor of one of the simpler sub-patterns P′_{X}={Y,Z}, P′_{Y}={X,Z} and P′_{Z}={X,Y}. Using the MinDiffCause metric described in detail above, the score given for pattern P={X,Y,Z} is 1.0 based on DiffCause(P,Z)=1.0 being the minimum DiffCause score amongst the sub-patterns. In that case, since the score for pattern P={X,Y,Z} is below the threshold θ, then pattern P={X,Y,Z} is removed from the list in favor of the simpler sub-pattern P′_{Z}={X,Y}.

In step 516, this now ranked and filtered list of patterns is provided as output for use in error analysis of the natural language parser 206. Advantageously, by way of the present techniques, the ranking amongst the patterns highlights the most remarkable patterns at the top of the list, while the filtering prunes redundant patterns from the list thereby vastly reducing the number of patterns to consider when evaluating performance of the natural language parser 206. Together, this ranking and filtering serves to provide a list of only the most remarkable and unique patterns, as opposed to the voluminous collection of many redundant patterns obtained through frequent pattern mining alone. The term ‘remarkable’ pattern P, as used herein, refers to a pattern P which causes large error and is not redundant.

The present ranked and filtered list of patterns can be used for the efficient and effective error analysis of the natural language parser 206 in a variety of different scenarios all with the goal of improving the overall performance of the natural language processor 202 in a succinct and meaningful way. Take, for instance, the scenario where there are multiple candidates for use as the natural language model 204, such as a model A and a model B. A host of available quantitative metrics like perplexity can be used to rate how each of these candidate models perform. However, this might not be enough to inform selection of one model over the other. For example, the outcome of these metrics might be quite similar for both models.

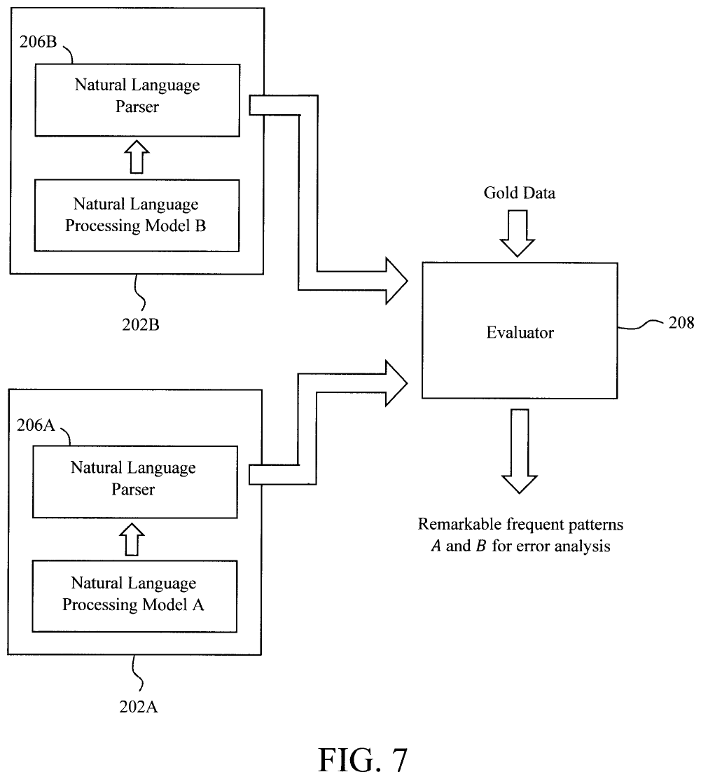

In that case, the present techniques can be employed to identify frequent error patterns. For instance, FIG. 7 illustrates an example where the present natural language parser evaluator system is used to compare different candidate natural language models (in this example candidate Model A and candidate Model B). Namely, in one instance, the natural language processor (given reference numeral 202A for clarity) employs candidate model A, and in another, the natural language processor (given reference numeral 202B) employs candidate model B. In each instance, the corresponding natural language parser 206A or 206B takes the text generated by the natural language model 204A or 204B, respectively, and analyzes syntactical relationships between words and phrases therein. The evaluator 208 can then be employed to perform methodology 500 described in conjunction with the description of FIG. 5 above, in order to provide ranked and filtered lists of patterns, one (of patternsA) for candidate Model A/natural language parser 206A and another (of patterns B) for candidate Model B/natural language parser 206B. In the same manner as described above, the input for evaluator 208 is the output from natural language parser 206A for patterns A, and the output from natural language parser 206B for patterns B, along with the corresponding gold data for the same sets of texts generated, e.g., by the natural language model 204A and the natural language model 204B, respectively. If it is found, for instance, that the output from candidate Model A sometimes contains critical errors, then it can be concluded with confidence that Model B is the best candidate.

Another illustrative scenario that might leverage the present techniques is as follows. Say, for example, that modifications are being made to improve natural language model 204. However, this results in a decrease of the quantitative score against expectations. The root cause of the problem (e.g., a part of additional training data contains problems) can be determined from the frequent (error) patterns P identified by the present techniques. For instance, say the pattern {DET,NOUN} is identified as a remarkable error pattern P by the present techniques. By observing the errors which contain this pattern manually, assume it is then found that the text “the” is sometimes tagged as “NOUN.” Upon investigation, it is found that “the” is tagged as “NOUN” in some of the training data. As such, this error (now identified) can be fixed in the training data to improve the natural language parser.

The present techniques are further described by way of reference to the following non-limiting examples. In one exemplary implementation, the present techniques were carried out on a corpus text set containing 12,158 texts in English. Part-of-speech (POS) tagging was used as the natural language parser. There were 17 POS pattern items E:

E={ADJ,ADV,INTJ,NOUN,PROPN,VERB,ADP,AUX,CCONJ,DET,NUM,PART,PRON,SCONJ,PUNCT,SYM,X}.

As is known to those in the art, these items correspond to adjective (ADJ), adverb (ADV), interjection (INTJ), noun (NOUN), proper noun (PROPN), verb (VERB), adposition (ADP), auxiliary (AUX), coordinating conjunction (CCONJ), determiner (DET), numeral (NUM), particle (PART), pronoun (PRON), subordinating conjunction (SCONJ), punctuation (PUNCT), symbol (SYM), and other (X). The following parameters were employed: min_support=10 meaning that the frequency of the itemset was 10 or more, and max_itemset_size=5 meaning that the number of elements in the itemset was 5 or less. Frequent pattern mining in this example resulted in 7,231 unique itemsets in the parse output and gold data.

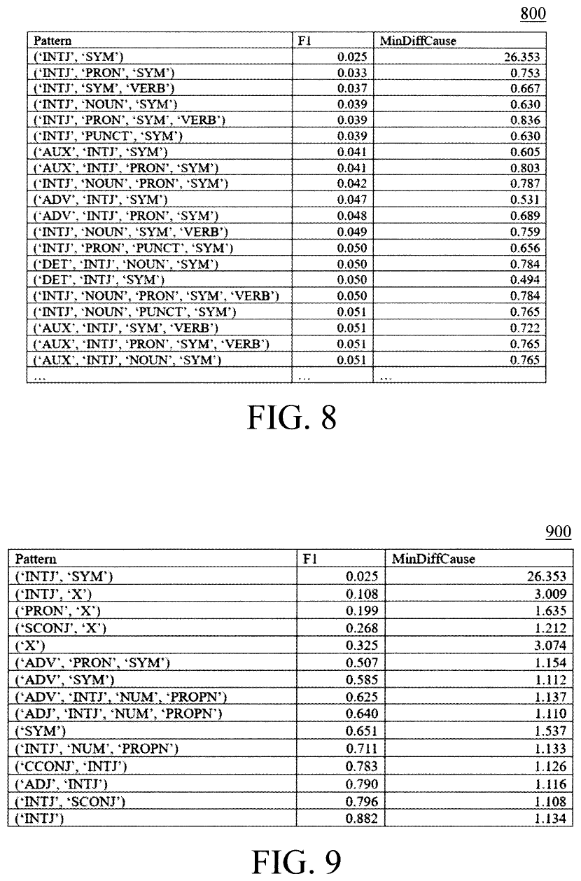

The results are shown in FIG. 8 and FIG. 9. Namely, FIG. 8 is a table 800 displaying the effectiveness of ranking the patterns by F1 value (from lowest to highest in descending order). For instance, as shown in table 800, F1(P) successfully emphasizes one of the most remarkable patterns {INT, SYM}. However, there are too many patterns (7,231) to check remarkable ones completely. Further, all of the patterns in the ranked list, except the first one {INT, SYM}, seem to be redundant since they contain both INTJ and SYM.

Advantageously, FIG. 9 is a table 900 displaying the effectiveness of then filtering the patterns by MinDiffCause score. For instance, as shown in table 900, MinDiffCause filters out (i.e., removes) redundant patterns. As highlighted above, the threshold θ can be adjusted to output more (or less) patterns. It is notable that, due to space limitations, table 800 of FIG. 8 displays only the top 20 out of the 7,231 patterns in the ranking. This is why some of the patterns shown in table 900 of FIG. 9 are not visible in table 800 of FIG. 8.

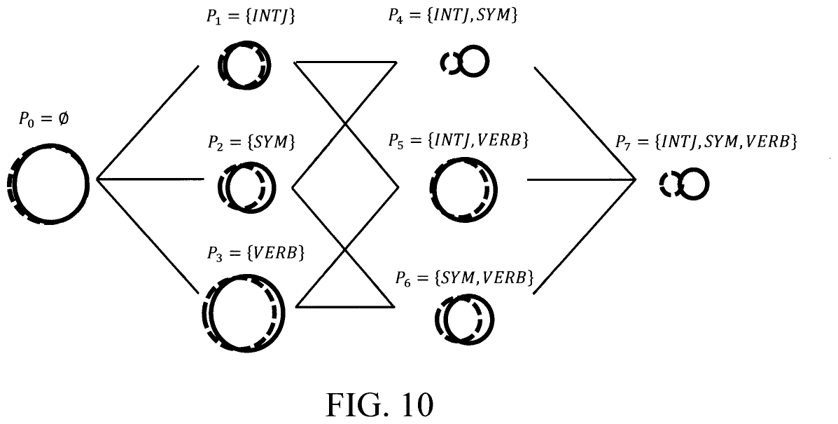

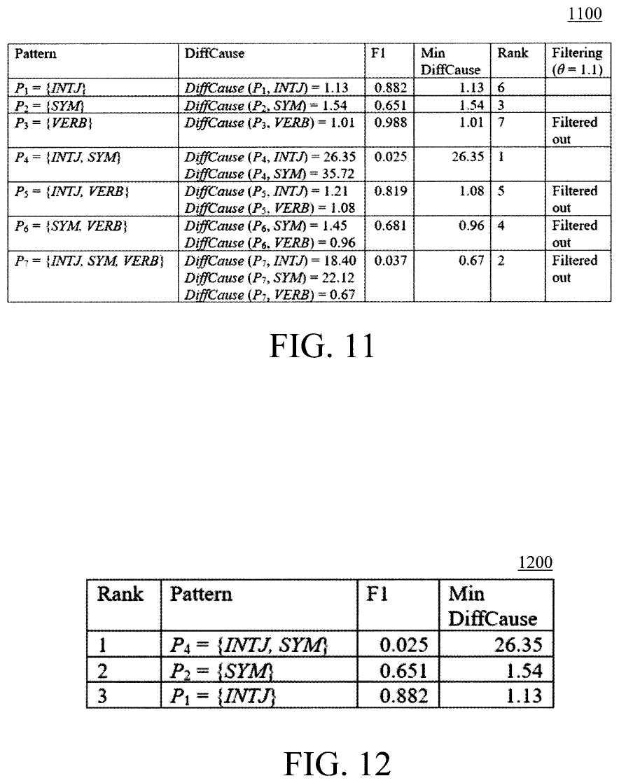

The sampled results for one of these reduced pattern items E′={INTJ, SYM, VERB} are illustrated in FIGS. 10-12. Since E′ is a subset of E, then the elements in E′ are reduced from those in E. Specifically, FIG. 10 is a diagram illustrating the transition of text sets Tₙₗₚ (P) (circles with a dashed outline) and T_{gold}(P) (circles with a solid outline) with pattern growth. FIG. 11 is a table 1100 displaying all of the patterns for reduced items E′ as well as the results of ranking and score calculation. The same convention DiffCause(P,e) is used as above. Thus, taking pattern P₄ as an example, DiffCause(P₄,INTJ)=26.35 and DiffCause(P₄,SYM)=35.72. Accordingly, MinDiffCause(P₄)=26.35.

As shown in table 1100, a threshold θ of 1.1 is used in this example for filtering-out (i.e., removing patterns from the list. In the same manner as above, those patterns having a MinDiffCause(P) below the threshold θ (in this case patterns P₃, P₅, P₆ and P₇) are removed from the list. See FIG. 12 which is a table 1200 displaying the list of ranked and filtered patterns output by the present techniques.

Although illustrative embodiments of the present invention have been described herein, it is to be understood that the invention is not limited to those precise embodiments, and that various other changes and modifications may be made by one skilled in the art without departing from the scope of the invention.

What is claimed is:

1. A natural language parser evaluation system, comprising:
a natural language parser; and
an evaluator configured to receive outputs of the natural language parser and gold data for a same set of texts, find patterns in the outputs of the natural language parser, determine error rates for each of the patterns found, calculate a score DiffCause for a change in the error rates between each of the patterns and sub-patterns of the patterns, rank the patterns in descending order by the error rates to provide a ranked list, and remove one or more of the patterns from the ranked list based on MinDiffCause which is a minimum of the score for the one or more patterns being below a threshold θ to provide a ranked and filtered list of the patterns for error analysis of the natural language parser.

2. The system of claim 1, wherein the evaluator is further configured to derive, for any given one of the patterns, a first text set where the outputs of the natural language parser match the given pattern, and a second text set where the gold data match the given pattern.

3. The system of claim 2, wherein the evaluator is further configured to determine a degree of overlap between the first text set derived from the outputs of the natural language parser and the second text set derived from the gold data for the given pattern that includes the given pattern in both the first text set and the second text set.

4. The system of claim 3, wherein the degree of overlap between the first text set and the second text set is determined using F1 scoring or Jaccard coefficient values.

5. The system of claim 1, wherein each of the patterns comprises an itemset, and wherein the sub-patterns are generated by removing one item from the itemset of each of the patterns.

6. The system of claim 5, wherein multiple sub-patterns exist for a given one of the patterns, and wherein the evaluator is further configured to calculate the score DiffCause for each of the multiple sub-patterns; and select among the multiple sub-patterns the score having a minimum value as MinDiffCause for the given pattern.

7. The system of claim 1, wherein the score DiffCause is calculated as a ratio of the error rates of the patterns and the sub-patterns.

8. The system of claim 1, wherein the threshold θ>1.0.

9. A method for evaluating a natural language parser, the method comprising:
receiving outputs of the natural language parser and gold data for a same set of texts;
finding patterns in the outputs of the natural language parser;
determining error rates for each of the patterns found;
calculating a score DiffCause for a change in the error rates between each of the patterns and sub-patterns of the patterns;
ranking the patterns in descending order by the error rates to provide a ranked list; and
removing one or more of the patterns from the ranked list based on MinDiffCause which is a minimum of the score for the one or more patterns being below a threshold θ to provide a ranked and filtered list of the patterns for error analysis of the natural language parser.

10. The method of claim 9, wherein the patterns are found in the outputs of the natural language parser and in the gold data using frequent pattern mining.

11. The method of claim 10, wherein the frequent pattern mining is performed using a threshold value for frequency of an itemset of ≥10.

12. The method of claim 9, further comprising:
deriving, for any given one of the patterns, a first text set where the outputs of the natural language parser match the given pattern, and a second text set where the gold data match the given pattern.

13. The method of claim 12, further comprising:
determining a degree of overlap between the first text set derived from the outputs of the natural language parser and the second text set derived from the gold data for the given pattern that includes the given pattern in both the first text set and the second text set.

14. The method of claim 13, wherein the degree of overlap between the first text set and the second text set is determined using F1 scoring or Jaccard coefficient values.

15. The method of claim 9, wherein each of the patterns comprises an itemset, and wherein the method further comprises:
removing one item from the itemset of each of the patterns to generate the sub-patterns.

16. The method of claim 15, wherein the removing results in multiple sub-patterns for a given one of the patterns, and wherein the method further comprises:
calculating the score DiffCause for each of the multiple sub-patterns; and
selecting among the multiple sub-patterns the score having a minimum value as MinDiffCause for the given pattern.

17. The method of claim 9, wherein the score DiffCause is calculated as a ratio of the error rates of the patterns and the sub-patterns.

18. The method of claim 9, wherein the threshold θ>1.0.

19. The method of claim 9, further comprising:
choosing between multiple natural language model candidates to use along with the natural language parser based on the ranked and filtered list of the patterns.

20. A method for evaluating a natural language parser, the method comprising:
receiving outputs of the natural language parser and gold data for a same set of texts;
finding frequent patterns in the outputs of the natural language parser and in the gold data independently, wherein the frequent patterns comprise itemsets that occur at least a predetermined number of times independently in either the outputs of the natural language parser or in the gold data;
determining error rates for each of the patterns found based on a degree of overlap between a first text set derived from the outputs of the natural language parser and a second text set derived from the gold data for a given one of the patterns based on an overlap of the texts that includes the given pattern in both the first text set and the second text set;
calculating a score DiffCause for a change in the error rates between each of the patterns and sub-patterns of the patterns;
ranking the patterns in descending order by the error rates to provide a ranked list; and
removing one or more of the patterns from the ranked list based on MinDiffCause which is a minimum of the score for the one or more patterns being below a threshold θ to provide a ranked and filtered list of the patterns for error analysis of the natural language parser.
